(19) United States
(12) Patent Application Publication
(10) Pub. No.: US 2008/0075949 A1
(43) Pub. Date: Mar. 27, 2008

(54) Coated Component Consisting of Quartz Glass, and Method for Producing Said Component

(75) Inventors: Ulrich Kirst, Mainz (DE); Wolfgang Stang, Kefenrod (DE); Juergen Weber, Kleinostheim (DE); Waltraud Werdecker, Hanau (DE); Martin Trommer, Schluechtern (DE); Joerg Becker, Niddatal (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Quarzglas GmH & Co. KG, Hanau (DE)

(21) Appl. No.: 11/661,160

(22) PCT Filed: Aug. 23, 2005
(86) PCT No.: PCT/EP05/09073

§ 371 Date: May 15, 2007

(30) Foreign Application Priority Data
Aug. 23, 2004 (DE) 10 2004 040 833.5
Oct. 28, 2004 (DE) 10 2004 052 312.6

(51) Int. Cl. C03C 17/02; C03B 19/02; C03C 17/25

(52) U.S. Cl. 428/332

(57) ABSTRACT

The invention relates to methods for producing a coated component consisting of quartz glass, according to which the component surface is at least partially provided with a SiO₂ glass composition that differs from the quartz glass of the base body. The aim of the invention is to provide a novel way of coating a quartz glass component with a SiO₂ glass composition that can be produced in a cost-effective, reproducible manner, with any thickness, and can fulfil various functions according to the concrete embodiment thereof. To this end, an amorphous slip containing SiO₂ particles is produced and applied to the surface of the base body, forming a slip layer which is dried and then vitrified, forming a SiO₂ glass composition. The quartz glass components coated in this way can be advantageously used especially in the production of semiconductors.

The present invention relates to a quartz glass component comprising a base body of quartz glass having a surface covered at least in part with a glass mass that differs in its optical, physical or chemical properties from quartz glass of the base body.

Moreover, the invention regards a method for producing a coated component of quartz glass by covering the surface of a base body of quartz glass at least in part with an SiO₂ glass mass which differs in its optical, physical or chemical properties from quartz glass of the base body.

Furthermore, the present invention relates to a method for producing a quartz glass component by preparing a slip from SiO₂ particles and a liquid, forming a porous green body therefrom by mold casting and drying, and densifying said body completely or in part by sintering.

Quartz glass is characterized Dy a low coefficient of thermal expansion, by optical transparence over a wide wavelength range and by high chemical and thermal resistance. Quartz glass components are used for many applications, e.g. in lamp manufacture as cladding tubes, bulbs, cover plates or reflector carriers for lamps and radiators in the ultraviolet, infrared and visible spectral range, or in semiconductor manufacture in the form of reactors and apparatus of quartz glass for the treatment of semiconductor components, jigs, bells, crucibles, protective shields or simple quartz glass components, such as tubes, rods, plates, flanges, rings or blocks. For producing special properties quartz glass is doped with other substances.

Especially when used in semiconductor production quartz glass components are exposed to high thermal stresses and chemically aggressive environments. With such applications good thermal insulation, high temperature stability or thermal shock resistance and high chemical resistance and freedom from contamination play an important role. Increasingly higher demands are made on the life of such quartz glass components.

As for the life of quartz glass components, attention must be paid to etch resistance and the absence of bubbles in near-surface areas. For instance, bubbles which are first closed in quartz glass reactors of semiconductor etch facilities and which are opened during use by removal of material often lead to a contamination of the semiconductors to be treated in the reactor, thereby terminating the service life of the quartz glass reactor. Fluorine-containing process gases which react with quartz glass, for example CHF₃ or CF₄, may also shorten the service life of a quartz glass component due to etch removal.

Moreover, in semiconductor manufacturing processes, such as sputtering or vapor deposition processes, there is often the problem that material layers deposit on all surfaces inside the reactor, particularly also on the quartz glass surfaces. The material layers may detach and then lead to particle problems. To avoid such a situation, the corresponding quartz glass surfaces are cleaned from time to time, which is normally carried out by etching with a fluorine-containing medium, particularly by means of hydrofluoric acid. The cleaning process is not only time-consuming and expensive, but also leads to the removal of quartz glass and gradual decrease in the wall thickness of the quartz glass components. The service life thereof is also limited by this. It is known that such material layers adhere to rough surfaces in a better way, whereby the frequency of the necessary cleaning cycles can be reduced and the service life of the mostly very expensive quartz glass components can thus be prolonged. The necessary surface roughness is achieved through mechanical removal methods, such as grinding or sand blasting, or by means of special etching solutions. Both methods have drawbacks. Cracks are e.g. produced during mechanical treatment of the surface, and these, in turn, create problems with respect to the particles.

To prevent contamination, it stands to reason to use quartz glass components of synthetic quartz glass, particularly in the manufacture of semiconductors. These, however, are expensive. An alternative that is less expensive in comparison therewith is described in DE 698 06 628 T2, which also discloses a quartz glass component for semiconductor production and a method according to the above-indicated type. It is suggested therein that a layer of synthetic quartz glass should be produced on a quartz glass component of natural raw material previously produced in a separate method step. To this end SiO₂ particles are produced by flame hydrolysis of a silicon-containing start compound in a deposition burner, and said particles are deposited on the surface of the component and there vitrified immediately with formation of a transparent, bubble-free, dense and smooth surface layer of synthetic quartz glass.

The surface layer is formed by a relative movement between the deposition burner and the component surface to be coated, the layer growth depending on the current deposition rate and the number of layers.

The preparation of surface layers by way of such a deposition method, particularly the reproducible preparation of uniform layer thicknesses, is long-winded and requires a great amount of equipment and a lot of time.

A further method for producing a smooth transparent surface layer from a porous green body produced by a slip casting method is described in DE 44 40 104 C2. An aqueous suspension of SiO₂ particles having a chemical purity of 99.9% SiO₂ is prepared and cast into a plaster mold. The surface of the resulting porous green body is subsequently heated locally by means of an oxyhydrogen flame to high temperatures ranging from 1650° C. to 2200° C., so that the opaque porous base material is converted in a near-surface area at a thickness of about 0.5 mm into transparent quartz glass (=vitrification).

However, it has been found that layer thicknesses of more than 2 mm cannot be achieved with the known method. Evidently, the vitrified transparent surface layer acts as a thermal insulator which makes an adequate heating of the layers positioned thereunder more difficult. This problem cannot be solved by higher flame temperatures because these lead to plastic deformation of the component and to vaporization of gaseous silicon monoxide (SiO).

It is therefore the object of the present invention to provide an inexpensive component of quartz glass, particularly for use in semiconductor manufacture, which is distinguished by high purity and high etch resistance (and thus a long life) and which does not create any particle problems, if possible.

Furthermore, it is the object of the present invention to provide a method for producing an SiO₂ glass mass on a quartz glass component, which glass mass can be produced at comparatively low costs and in a reproducible manner and with any desired thickness and shape and can fulfill different functions, depending on its concrete design, particularly in semiconductor production.

As for the method, this object starting from the above-mentioned method is achieved according to the invention in that a slip containing amorphous SiO₂ particles is produced and applied to the surface of the base body with formation of a slip layer, the slip layer is dried and subsequently vitrified with formation of the SiO₂ glass mass.

In the method according to the invention the coating of the quartz glass base body is produced through a slip route. The volume of the SiO₂ glass mass is formed completely, or at least to a substantial degree, by SiO₂, which is prepared and provided through a slip method. A particular technical challenge is to prevent any tearing of the slip layer during drying or vitrification—though the volume of the layer is shrinking—without the quartz glass of the base body being in a position to yield accordingly.

To this end an aqueous, homogeneous, stable and castable slip is first of all produced, the slip containing amorphous SiO₂ particles. The slip is applied as a “slip layer” to the base body and is subsequently dried and vitrified. Due to interactions the amorphous SiO₂ particles already stabilize the slip layer in the pasty and dried state and promote the sintering activity, which permits a sintering of the dried slip layer at a comparatively low temperature with formation of a dense and crack-free SiO₂ glass mass.

The SiO₂ particles consist of synthetically produced SiO₂ or of purified, naturally occurring raw material, as is described in the above-mentioned DE 44 40 104 C2.

Particle size and distribution of the SiO₂ particles have impacts on the rheological properties of the slip, on the drying shrinkage of the slip layer and on the surface roughness of the resulting SiO₂ glass mass. For instance, the use of rather coarse SiO₂ particles helps to enhance the intrinsic viscosity or pseudoplasticity, to reduce drying shrinkage and to increase the surface roughness of the SiO₂ glass mass.

The slip layer is dried by removing moisture at room temperature, by heating or by freeze drying. After drying the slip layer is vitrified in that it is heated to a high temperature which accomplishes a sintering of the SiO₂ particles and the formation of a dense and crack-free glass mass of opaque, partly opaque and partly transparent or completely transparent SiO₂, the glass mass covering the whole surface of the base body or part thereof. The SiO₂ glass mass is configured in the form of a flat layer, or it assumes a shape which forms a functional part of the component, e.g. as a thickening or bead.

The base body is a body of quartz glass which is made from synthetically produced or naturally occurring raw materials. The quartz glass of the base body may be transparent or opaque (translucent).

Preferably, SiO₂ particles are used for the formation of the glass mass, the particles having a size in the range of not more than 500 μm, preferably not more than 100 μm, SiO₂ particles with particle sizes ranging between 1 μm and 50 μm accounting for the largest volume portion.

SiO₂ particles in this order show advantageous sintering characteristics and a comparatively low drying shrinkage. It has been found that in the case of such a slip the slip layer can be dried and vitrified particularly easily without the formation of cracks. This may be due to an appropriately small drying shrinkage and to interactions of the SiO₂ particles among one another, which may even lead to the formation of molecular SiO₂ bonds and which facilitate drying and sintering.

This is promoted by the polar nature of the aqueous phase of the slip and by a procedure in which the SiO₂ particles are prepared by the wet milling of SiO₂ start grains.

The desired particle size distribution is here adjusted by the homogenizing process of the aqueous slip, the SiO₂ particles, starting from comparatively coarse grains having diameters ranging for example between 200 μm and 5000 μm, being comminuted during homogenization in dependence upon their degree of consolidation. During wet milling, SiO₂ particles of any size are formed inside the slip, even such particles that already form the above-described bonds in the slip due to interactions, which improves the stability of the slip layer.

The cristobalite amount in the dried SiO₂ slip layer should be not more than 1% by wt. because, otherwise, a crystallization process may take place during vitrification of the slip layer, which may lead to waste of the component.

A roughening of the surface of the base body effects improved adhesion of both the slip layer and the dense SiO₂ glass mass produced therefrom by vitrification.

Roughening is carried out mechanically (for example by grinding or sand blasting) or chemically (by etching), and the surface should here have a mean surface roughness Rₐ of at least 0.5 μm.

Process techniques that are known per se, for instance spraying, electrostatically supported spraying, flooding, flinging, immersion, pressing, extraction and stripping off (doctor blade method) or spreading, are suited for applying the slip.

Moreover, the risk of crack formation during vitrification can be reduced by way of a suitable temperature control. The dried slip layer is preferably vitrified at a maximum temperature ranging between 1000° C. and 1600° C., preferably between 1100° C. and 1400° C., which is low in comparison with the above-described method.

The low maximum temperature prevents an excessively rapid densification of the outer surface areas of the slip layer during vitrification. Such a rapid densification would prevent the further progression of a vitrification front due to its heat-insulating effect, thereby rendering the complete vitrification or the formation of thick vitrified layers more difficult.

In a particularly preferred variant of the method, the dried slip layer is vitrified in a hydrogen atmosphere.

Due to its high diffusion rate in quartz glass, hydrogen is particularly suited for heat transfer. A good heat transportation has the effect that a temperature gradient that is as flat as possible is formed between the high temperature prevailing on the surface and the low temperature prevailing in the interior of the SiO₂ glass mass or the portion of the porous dried slip layer that has not been vitrified yet. Even at low vitrification temperatures this guarantees a progression of the melt front from the outside to the inside and thus a vitrification also of inner portions of the slip layer. A hydrogen content of at least 70% is adequate for this. This variant of the method therefore facilitates, in particular, the formation of completely transparent SiO₂ glass masses with layer thicknesses up to the range of several millimeters. Apart from hydrogen, the atmosphere during vitrification may e.g. also contain nitrogen and preferably helium.

As for necessary safety measures, a vitrification process in hydrogen is however comparatively expensive. For applications in which an opaque or less thick transparent SiO₂ glass mass is adequate, the dried slip layer may also be vitrified in air. A vitrification in air normally yields opaque SiO₂ glass masses. However, it has been found that slip layers can even be vitrified in air into a transparent layer having layer thicknesses of up to about 4 mm on condition that the base body itself consists of transparent quartz glass. Vitrification in air does not require any special safety measures and is inexpensive.

As an alternative to vitrification in a furnace, it has also turned out to be useful when the dried slip layer is vitrified by means of a burner flame.

This variant of the method yields a flame-polished surface that is also free from cracks, the heat action lasting for a short period of time and being easily limited to the areas covered with an SiO₂ slip layer to be vitrified, so that plastic deformations can substantially be avoided.

The same advantageous effect is achieved by vitrification by means of laser (e.g. CO₂ laser).

Surprisingly, a surface vitrified by means of laser shows relatively few bubbles in comparison with a surface vitrified by means of a burner flame. This can be explained by the fact that the standard burner gases, such as oxygen and hydrogen, which lead to the formation and inclusion of water or of hydroxyl groups in the quartz glass, are not present or only present in small amounts during “laser vitrification”. This leads to a considerable improvement of the etch resistance of the component together with a small particle generation at the same time.

If a particularly large thickness of the SiO₂ glass mass is needed, the layer can be successively reinforced by performing the method of the invention several times. This variant of the method is e.g. advantageously used when the SiO₂ glass mass is formed as a thickening of the base body in portions.

This thickening of the base body in portions can fulfill many functions. For instance, it can serve in a cylindrical base body as a surrounding bead for mounting or sealing in case of contact with a mating piece, or it may be configured as a terminal thickening of a rod-shaped or tubular base body from which a predetermined final shape is mechanically formed, such as a spherical ground part or a flange.

Moreover, it has turned out to be useful when dopants in the form of yttrium, aluminum, nitrogen, carbon or the compounds thereof are added to the slip.

In this variant of the method one dopant or several dopants that develop a specific action in quartz glass, such as a coloring action or a glass structure-reinforcing action, are introduced into the SiO₂ glass mass. For instance, an addition of aluminum in the quartz glass of the glass mass forms Al₂O₃, which enhances the etch resistance of quartz glass and thus prolongs the service life of the quartz glass component. Additions of nitrogen or carbon which are incorporated in the form of nitrides or carbides into the quartz glass structure and effect a stiffening of the glass structure and thus also an improved etch resistance show similar effects. Suitable start substances, such as silazanes or siloxanes, are distributed in the slip in a particularly uniform manner, resulting in the end in a homogeneous doping of the quartz glass of the glass mass. A particularly advantageous effect with respect to the dry etching resistance of the component is achieved through the addition of yttrium, which is present in the quartz glass as Y₂O₃.

The SiO₂ glass mass prepared in this way is distinguished by high adhesion to quartz glass and can be easily modified in its properties by simply changing the process, e.g. the vitrification temperature or the addition of dopants, and adapted to a large number of specific applications. Suitable configurations for use in semiconductor manufacture will be described in more detail further below.

In an extreme case the SiO₂ thick layer is entirely transparent and extends over the whole quartz glass component. In this case, however, special measures are required with respect to the start material to be used and with respect to the process conditions. These will be described in more detail in the following.

Therefore, the above-mentioned object is achieved according to the invention with respect to the method, starting from the method mentioned as the second one at the outset, in that the SiO₂ particles are amorphous, prepared by wet-milling SiO₂ start grains in the liquid and have particle sizes in the range of not more than 500 μm during mold casting, SiO₂ particles with particles sizes in the range between 1 μm and 50 μm accounting for the greatest volume portion, and that the green body is densified by heating in a hydrogen-containing atmosphere.

This embodiment of the method according to the invention is employed whenever a transparent “SiO₂ glass mass” with a particularly large thickness is desired, which in an extreme case encompasses the whole wall thickness of the quartz glass component. In the last-mentioned case, it thus consists of a body that is free from pores or very poor in pores and is obtained by vitrifying a green body obtained in the slip casting method. With the help of the known method, if complete fusion of the green body is to be avoided, only an opaque and pore-containing sintered product is usually obtained from such green bodies even at high vitrification temperatures. Even if a very high temperature is used, only a thin transparent surface layer will be obtained on an opaque green body, as has been described above.

It has been found that the formation of much thicker vitrified transparent layers makes high demands on both the start material of the slip and the vitrification conditions. These demands will be explained in the following.
1. On the one hand, the formation of the green body requires, according to the invention, the use of a slip in which amorphous SiO₂ particles are present that have been prepared by wet milling SiO₂ start grains in the liquid of the slip and that have a particle size distribution in which the particle sizes are in the range of not more than 500 μm, wherein SiO₂ particles including particles with sizes ranging between 1 μm and 50 μm account for the greatest volume portion.
   As has already been described above, SiO₂ particles in this order show advantageous sintering characteristics. It has been found that, in such a slip, drying and vitrification are particularly easily possible without the formation of cracks, which is due to low drying shrinkage and to interactions between the SiO₂ particles, which in the liquid phase may even lead to the formation of molecular SiO₂ bonds and are “frozen” in the green body and facilitate drying and sintering.
   The SiO₂ particles consist of synthetically prepared SiO₂ or of purified and naturally occurring raw material, as described in DE 44 40 104 C1.
2. In the method of the invention, vitrification is carried out under reducing conditions by heating the green body in an atmosphere containing hydrogen. The green body is thermally consolidated in this process, and at least the surface is completely vitrified in the form of an SiO₂ glass mass. On account of its high diffusion rate in quartz glass the hydrogen guarantees a rapid temperature compensation during sintering between the higher temperature prevailing on the surface and the lower temperature prevailing in the interior of the green body. The resulting temperature gradient which is particularly small facilitates the progression of the melt front from the outside to the inside despite a comparatively low maximum temperature in the area of the surface (which does not yet effect a complete dense sintering).

It has been found that a complete pore-free vitrification of layers with layer thicknesses of up to 10 mm is possible with this method. If crystallization is to be avoided during sintering, the cristobalite content of the start material should be not more than 1% by wt. (based on the dry matter of the green body).

Preferably, the amorphous SiO₂ particles have particles sizes of not more than 50 μm during mold casting. Smaller particles are distinguished by a higher sintering activity and facilitate complete vitrification of the layer.

Ideally, sintering is carried out in a pure hydrogen atmosphere. Particularly for reasons of safety (risk of explosion) the hydrogen content is at least 70% by vol. during sintering.

Apart from hydrogen, the atmosphere may also contain e.g. nitrogen and preferably helium during vitrification. A hydrogen content of at least 70% is adequate.

The vitrification temperature is not more than 1700° C., preferably not more than 1400° C., and does not lead to a “dense sintering” of near-surface regions and thus to premature formation of a vitrified layer acting as a “heat insulation layer”. The low sintering temperature is achieved through both the above-described start material and the low temperature gradient due to the hydrogen-containing sintering atmosphere.

As for the quartz glass component, the above-mentioned object starting from the above-described quartz glass component is achieved according to the invention in that the glass mass is prepared from a dried vitrified slip mass containing amorphous SiO₂ particles.

Such an SiO₂ glass mass is obtained by applying a mass of a slip containing SiO₂ particles onto the surface of the base body, and by subsequent drying and vitrification of the mass, as has been explained above in more detail for the method of the invention. The SiO₂ glass mass consists completely, or for the greatest part, of SiO₂, which has been prepared and applied by means of the slip method, and it covers the component surface entirely or only in part. It forms a flat layer on the component surface and contributes to the geometrical shape of the component, thereby forming a functional constituent of the component, such as a thickening or a bead, which may e.g. serve as a flange or ground part. If a smooth and dense surface is needed, such a surface is preferably obtained by fire polishing.

The surface of the SiO₂ glass mass produced in this way is obtained without any tools in the melt flow by vitrification by means of a burner flame or in a furnace and is at least distinguished by freedom from cracks, and it can be worked chemically or mechanically, e.g. by grinding, polishing or blasting.

Preferably, however, the SiO₂ glass mass is formed with a surface shaped without any cracks and tools and having a mean surface roughness Rₐ of at least 0.5 μm.

After vitrification the surface of the SiO₂ glass mass is not very smooth. On the contrary, it is rather marked by a certain surface roughness. The surface roughness is accomplished due to the manufacture thereof by means of the method of the invention on account of the use of a slip containing SiO₂ particles for the formation of the glass mass. Depending on the size and size distribution of the amorphous SiO₂ particles contained in the slip, a surface roughness is obtained automatically after vitrification, without the need for any further measures such as a roughening etching process or a mechanically roughening surface treatment.

The “natural” roughness of the surface of the component of the invention predestines it for use in semiconductor manufacture, for it brings about an improved adhesion of material layers and thereby leads to a smaller particle load during use of the component in semiconductor manufacture. Moreover, the component permits longer cleaning cycles, which is accompanied by a longer service life.

The definition of the surface roughness Rₐ follows from EN ISO 4287, and the measuring conditions from EN ISO 4288 (this applies to the case of a non-periodic surface profile). The mean surface roughness Rₐ of the SiO₂ glass mass is at least 0.5 μm, preferably at least 1.0 μm.

It has turned out to be of advantage when the SiO₂ glass mass consists of material with the characteristics of the species with respect to the base body.

“Material with the characteristics of the species” is here understood such that the SiO₂ contents of glass mass and base body differ from each other by not more than 3% by wt. at the most, and that in the presence of dopants in the glass mass or in the quartz glass of the base body these influence the coefficient of expansion of both in a similar way. This accomplishes a particularly high adhesion of the glass mass to the base body, and particularly a high thermal shock resistance of this composite.

The SiO₂ glass mass can be made opaque, partly opaque and transparent or completely transparent.

The complete transparence of the SiO₂ glass mass is preferred if emphasis is laid on high density, absence of pores and high etch resistance.

By contrast, an embodiment of the quartz glass component of the invention with an opaque or at least partly opaque SiO₂ glass mass is preferred if the SiO₂ glass mass is to serve as a heat barrier. An opaque SiO₂ glass mass is normally white, reflects infrared radiation and therefore shows a great heat-insulating action.

In a further preferred embodiment of the component of the invention, the SiO₂ glass mass forms a thickened portion of the base body.

The thickened portion is for instance formed as a bead or terminal portion of a cylindrical base body. In the immediately produced form or following a finishing treatment, it has assigned to it a given function, e.g. to mount the component.

Depending on the intended use of the quartz glass component, it is advantageous when the SiO₂ glass mass contains dopants in the form of yttrium, aluminum, nitrogen, carbon, or the compounds thereof. Reference is here made to the corresponding explanations given above with respect to the method according to the invention.

The invention shall now be explained in more detail with reference to embodiments and a drawing. The drawing shows in detail in

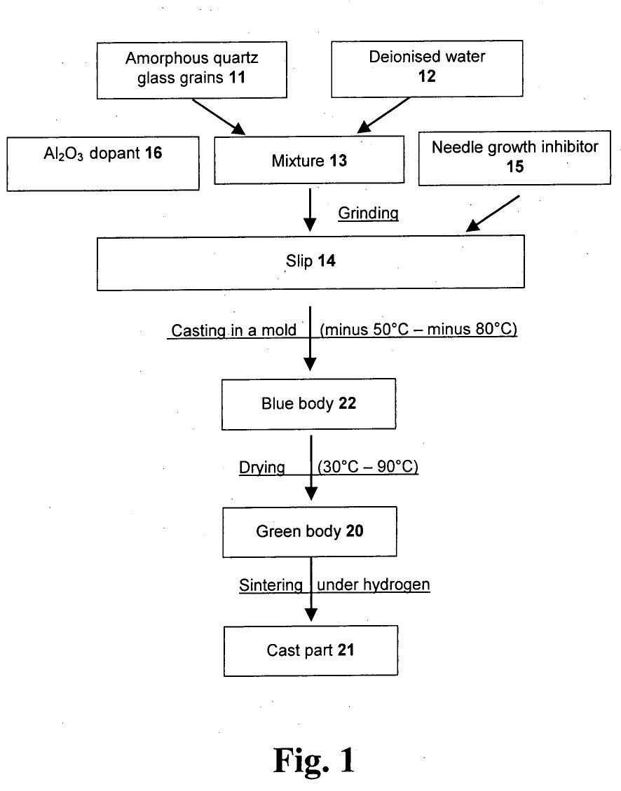

FIG. 1 a flow diagram for explaining a procedure for producing a quartz glass component provided with an SiO₂ glass mass, for use in semiconductor manufacture, with reference to the method of the invention;

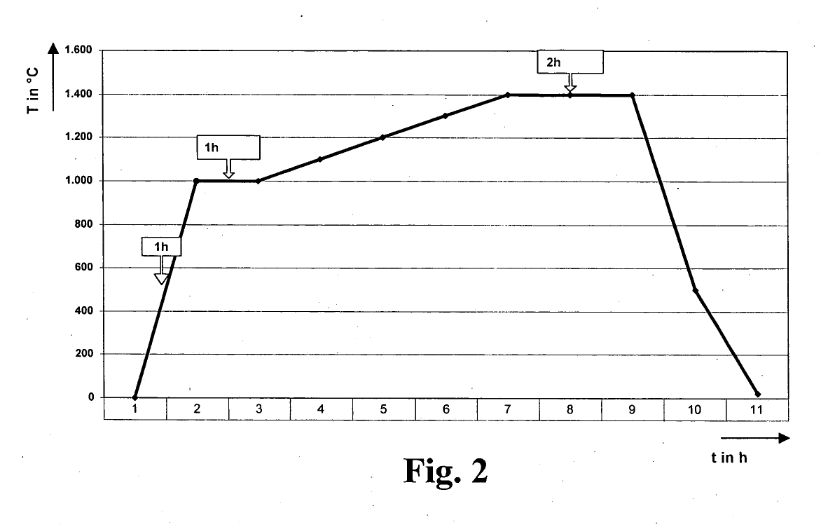

FIG. 2 a heating profile for vitrifying a slip layer on a quartz glass base body and for sintering a green body according to the invention;

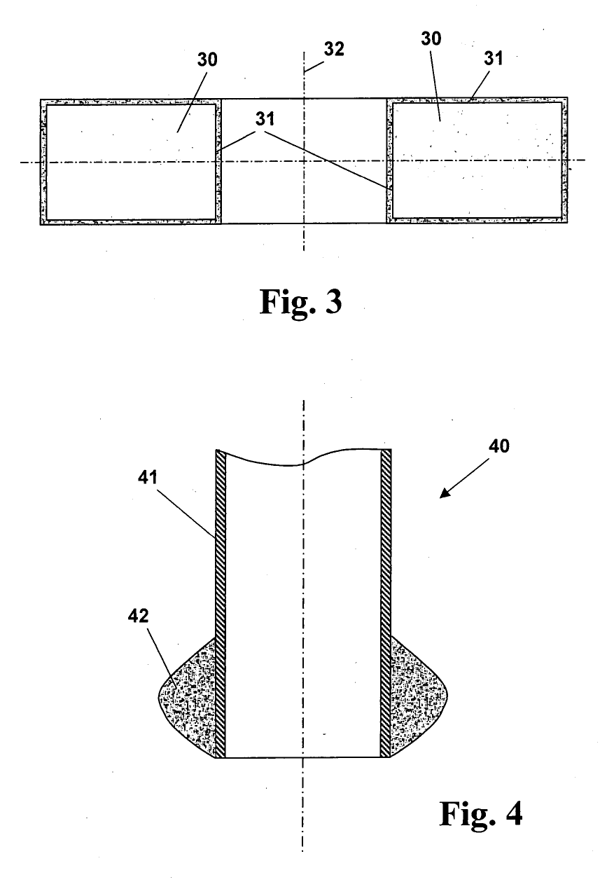

FIG. 3 a quartz glass flange for a single wafer holder, the surface of which is entirely formed by a transparent SiO₂ glass mass, in a schematic sectional illustration; and

FIG. 4 a semi-finished product for spherical grinding, in a schematic illustration.

### 1. PREPARATION OF A SLIP LAYER ON A BASE BODY OF QUARTZ GLASS

### Example 1

A homogenous base slip is prepared. For a batch of 10 kg base slip (SiO₂-water slip), 8.2 kg of amorphous quartz glass grains of natural raw material with grain sizes in the range between 250 μm and 650 μm are mixed with 1.8 kg deionized water of a conductivity of less than 3 μS in a drum type mill lined with quartz glass and having a capacity of about 20 liters. The quartz glass grains were purified before in a hot chlorination method. Attention is paid that the cristobalite content is less than 1% by wt.

This mixture is ground by means of grinding balls of quartz glass on a roller block at 23 rpm for three days to such an extent that a homogenous base slip with a solids content of 79% is obtained. In the course of the grinding process the pH is lowered to about 4 due to the dissolving SiO₂.

Further amorphous SiO₂ grains with a grain size of about 5 μm are added to the resulting homogenous base slip until a solids content of 84% by wt. is achieved. The mixture is homogenized in a drum type mill at a speed of 25 rpm for 12 hours. The resulting slip has a solids content of 84% and a density of 2.0 g/cm³. The SiO₂ particles obtained after grinding of the quartz glass grains in the slip 14 show a particle size distribution which is characterized by a D₅₀ value of about 8 μm and by a D₉₀ value of about 40 μm.

An annular quartz glass flange having an outer diameter of 300 for a single-wafer holder is immersed into the slip for a few seconds, the surface of which has been adjusted previously by chemical etching (deep freezing) to a mean surface roughness Rₐ of 2 μm.

A uniform closed slip layer with a thickness of about 0.35 mm is thereby formed on the quartz glass flange. This slip layer is first dried at room temperature for about 5 hours and is then dried in air by means of an IR radiator. The dried slip layer is free from cracks and it has a mean thickness of about less than 0.3 mm.

The slip used is preferably dilatant with this flat application to the quartz glass flange. The rheological property of the slip, which is called “dilatancy”, manifests itself in that its viscosity increases with the shear rate. This has the effect that after the omission of the shear forces, i.e. after application of the slip as a slip layer to the quartz glass component, the viscosity decreases, which facilitates the formation of a uniformly thick slip layer.

### Example 2

A base slip is produced, as has been described above with reference to Example 1. Instead of the addition of further amorphous SiO₂ grains having a grain size of 5 μm, further amorphous SiO₂ grains with a grain size of about 40 μm are added to the homogeneous stable base slip until a solids content of 84% by wt. is obtained. The mixture is homogenized in a drum type mill at a speed of 25 rpm for 12 hours.

The resulting slip has a solids content of 84% and a density of 2.0 g/cm³. The SiO₂ particles in the slip 14 as obtained after grinding of the quartz glass grains show a particle size distribution that is characterized by a D₅₀ value of about 14 μm and by a D₉₀ value of about 40 μm.

Apart from the amorphous SiO₂ particles, the slip may also contain precursor components for the formation of SiO₂ particles. These are hydrolyzable silicon compounds as are used in sol-gel methods for producing SiO₂. Due to their hydrolysis such precursor components form molecular bonds in the slip layer, they bring about consolidation and thereby facilitate sintering. On the other hand, however, at a high concentration they also induce a considerable drying shrinkage and may contribute to the formation of cracks, which limits the proportion of such precursor components in the slip.

In the slip, an end of a quartz glass tube, the surface of which has been adjusted before by chemical etching (deep freezing) to a mean surface roughness Rₐ of 2 μm, is immersed up to a depth of about 3 cm for a few seconds. At the end of the quartz glass tube a closed slip layer with a thickness of about 0.4 mm is formed due to the nonrecurring short immersion process. This slip layer is dried at room temperature for about 10 minutes. The immersion and drying process is repeated so many times that a slip mass in the form of a bead-shaped thickening with a mean thickness of about 15 mm is formed at the end of the quartz glass tube. This thickening is subsequently dried in air.

The slip used is preferably pseudoplastic in this zonewise application to the quartz glass tube. The rheological property of the slip, which is called “pseudoplasticity”, manifests itself in that its viscosity decreases with the shear rate. This has the effect that after the omission of the shear forces, i.e. after application of the slip, the viscosity increases, which facilitates the formation of a bead-shaped slip layer.

### 2. Vitrification of the Slip Layer

### Example 3

The slip layer which has been produced and dried with reference to Example 1 and provided on the quartz glass flange is subsequently vitrified in a pure hydrogen atmosphere in a sintering furnace on the basis of the heating profile shown in FIG. 2.

The heating profile comprises an initially steep heating ramp within which the slip layer is heated from room temperature within one hour to a lower heating temperature of 1000° C. At the lower heating temperature the slip layer is kept for one hour and is then heated via a second flat heating ramp for four hours to an upper heating temperature of 1400° C. The hold time at the upper heating temperature is two hours in the embodiment. The slip layer is completely vitrified, transparent and free from bubbles after this process.

Subsequent cooling is carried out in the furnace in hydrogen down to a temperature of 500° C. at a controlled cooling rate of 15° C./min and then in a still closed furnace by way of free cooling.

FIG. 3 diagrammatically shows the quartz glass flange coated in this manner by way of a sectional illustration. The flange consists of an annular base body 30 of transparent quartz glass which is surrounded on all sides by a crack-free and transparent SiO₂ layer 31 which for reasons of illustration is plotted in FIG. 3 with an exaggerated thickness. The central axis is designated by reference numeral 32.

The SiO₂ layer 31 on the quartz-glass flange base body 30 has a mean layer thickness of about 0.2 mm. It is distinguished by a density corresponding to that of quartz glass, and by a high thermal shock resistance. Due to its final treatment in the sintering furnace it has a crack-free surface with a mean “natural” surface roughness (Rₐ) of about 1.2 μm, which is obtained exclusively, i.e. without any further finishing, due to its production using a slip containing SiO₂ grains. Material layers adhere to the surface in a particularly firm manner, resulting in a prolongation of the cleaning cycles in comparison with known quartz glass flanges and thus in a longer service life.

### Example 4

A uniform closed slip layer with a thickness of about 0.35 mm is formed on the quartz glass flange and dried, as described above with reference to Example 1. The slip layer is subsequently vitrified by means of a CO₂ laser, with the laser beam diameter having been expanded by means of an optical device to about 5 mm, and the laser beam having been being guided at a translation rate of 500 mm/min in raster form over the surface to be vitrified. The distance between laser exit and surface was constantly kept at 300 mm.

This yields a crack-free and transparent SiO₂ layer which is distinguished by a particularly low bubble content and the features and quality of which correspond otherwise to the layer 31 described above with reference to FIG. 3.

### Example 5

The bead-like thickened slip layer at the end of the quartz glass tube, which has been produced and dried on the basis of Example 1, is subsequently vitrified by means of an oxyhydrogen burner. To this end the thickening is heated for such a long period of time until a completely transparent, flame-polished and dense surface is obtained.

FIG. 4 shows a section of the resulting semifinished product 40 of quartz glass by way of a sectional illustration. The semifinished product 40 serves to produce a spherical ground part of quartz glass. For this purpose, an end of the quartz glass tube 41, which has an outer diameter of 25 mm and a wall thickness of 2 mm, is provided with a vitrified thickening 42 of SiO₂ having a maximum thickness of 15 mm, which, as has been described above, has been produced by using an SiO₂ slip. The thickening 42 is subsequently treated mechanically and flame-polished. It is distinguished by freedom from cracks and a high density that corresponds to that of quartz glass.

### Example 6

In a further embodiment, a slip layer is produced on a rod of transparent, synthetically produced quartz glass with a hydroxyl group content of 250 wt ppm by immersion and is subsequently dried, as described in Example 1. After drying the thickness of the slip layer is 0.3 mm. Vitrification is carried out in a furnace in air, the heating profile corresponding to the one shown in FIG. 2 and explained in more detail above with reference to Example 3, but with the difference that the hold time of two hours at the maximum temperature of 1400° C. is omitted. Cooling starts immediately after said temperature has been reached.

Surprisingly, the resulting vitrified SiO₂ glass mass is fully transparent, and it has an average thickness of 0.2 mm and a mean roughness Rₐ of 1.2 μm.

### Example 7

The dried slip layer produced on the basis of Example 6 on the quartz glass rod is introduced into a sintering furnace for vitrification and is vitrified there in air.

The heating profile corresponds to that as shown in FIG. 2 and explained in more detail above with reference to Example 3, with the difference that the maximum temperature is not 1400° C., but just 1050° C. At this temperature, the coated quartz glass rod is held for two hours and then cooled.

Although the slip layer is completely sintered and consolidated by this temperature treatment, the resulting SiO₂ glass mass shows a high density of about 2.15 g/cm³, but is substantially still opaque. Opacity manifests itself in that the direct spectral transmission is below 10% in the wavelength range between 190 nm and 2650 nm.

### Example 8

Starting grains are prepared that consist of 95% by wt. of SiO₂ and 5% by wt. of Y₂O₃. To this end pure quartz glass powder having a mean particle diameter of about 200 μm is mixed with a yttrium oxide powder having a mean particle size of about 5 μm, and the powder mixture is molten in an electric furnace in vacuum in a graphite mold. The quartz glass doped with yttrium oxide, which has been produced in this way, is comminuted and processed by wet milling, as described with reference to Example 1, into a homogeneous base slip having a solids content of 79%. A solids content of 84% by wt. is set by adding further quartz glass grains doped with Y₂O₃ and having a grain size of about 5 μm.

This mixture is further processed, as described with reference to Example 1, so that the resulting doped SiO₂ particles in the slip show a particle size distribution which is characterized by a D₅₀ value of about 8 μm and a D₉₀ value of about 40 μm.

A uniform closed slip layer with a thickness of about 35 mm is produced on a flange by using said slip and said layer is dried, as has been described above with reference to Example 1. The resulting slip layer is then vitrified into a transparent quartz glass layer doped with 5% by wt. of Y₂O₃. It is distinguished by a particularly high resistance to etching gas.

### 3. Preparing and Sintering a Green Body Obtained by Slip Casting

The production of a fully vitrified and transparent quartz glass body by sintering a green body obtained according to the slip casting method shall now be explained in more detail with reference to the flow diagram of FIG. 1.

A slip body of quartz glass grains 11 and water 12 is prepared, as has been described above with reference to Example 1. In addition, finely divided Al₂O₃ powder 16 is added to the slip in an amount of 500 wt ppm (based on the SiO₂ portion). This mixture 13 is ground in a drum type mill into a homogenous slip 14 having a solids content of 82%. The SiO₂ particles obtained after grinding in the slip 14 have a particle size distribution with particle sizes in the range between 0.45 μm and 50 μm, SiO₂ particles with particle sizes in the range between 1 μm and 10 μm accounting for the greatest volume portion (D₅₀ value). 16% by wt. of glycerol (based on the remaining liquid phase), which acts as needle growth inhibitor 15, is additionally supplied to this mixture and the mixture is homogenized for 12 hours. Homogenization takes place in the drum type mill at a speed of 25 rpm.

A green body 20 is subsequently prepared from the homogeneous slip 14. To this end the slip 14 is cast into a tubular membrane mold of vacuum-molded silicon which is embedded in carbon dioxide snow (dry ice). This leads to a rapid freezing of the slip 14 into a blue body 22 in the form of a rod having an outer diameter of 10 mm. The addition of glycerol helps to form a homogenous structure that is free from ice needle structures. The shock-frozen blue body 22 is removed from the membrane mold and directly introduced, in the frozen state, into a forced-air drying cabinet preheated to 80° C. and is dried therein at this temperature for several hours. Due to the continuous evaporation and removal of moisture from the surface, recondensation of moisture and repeated superficial freezing, which would entail the formation of needle crystals and disturb the green body structure, are prevented.

The dried green body 20 is subsequently sintered on the basis of the heating profile illustrated in FIG. 2 in a furnace in a pure hydrogen atmosphere, the hold time being four hours (instead of two hours) at the upper heating temperature.

A complete vitrification of the green body is thereby accomplished, and a rod-shaped casting 21 is obtained with an outer diameter of about 10 mm, the casting consisting of transparent quartz glass.

1. A method for producing a coated component of quartz glass, said method comprising: covering a surface of a base body of quartz glass at least in part with an SiO₂ glass mass which differs in its optical, physical or chemical properties from quartz glass of the base body, wherein a slip containing amorphous SiO₂ particles is produced and applied to the surface of the base body so as to form a slip layer, and the slip layer is dried and subsequently vitrified so as to form an SiO₂ glass mass, wherein the SiO₂ particles have particle sizes in a range of not more than 100 μm, and wherein a majority by volume of the SiO₂ particles have particle sizes in a range from 1 μm to 50 μm, and wherein the SiO₂ particles are produced by wet milling SiO₂ start grains.

2. The method according to claim 1, wherein a dried slip layer is vitrified by heating said dried slip layer to a temperature ranging from 1000° C. to 1600° C.

3. The method according to claim 1, wherein a dried slip layer is vitrified in a hydrogen atmosphere.

4. The method according to claim 1, wherein a dried slip layer is vitrified using a burner flame.

5. The method according to claim 1, wherein a dried slip layer is vitrified using a laser.

6. The method according to claim 1, wherein the SiO₂ glass mass is formed as a thickening in portions of the base body.

7. The method according to claim 1, wherein dopants chosen from the group consisting of yttrium, aluminum, nitrogen, carbon and any compounds thereof are added to the slip.

8. A method for producing a quartz glass component, said method comprising: preparing a slip from SiO₂ particles and a liquid, forming a porous green body therefrom by mold casting and drying, and densifying said porous green body completely or in part by sintering, wherein the SiO₂ particles are amorphous, are prepared by wet-milling SiO₂ start grains in the liquid, and have particle sizes in a range of not more than 500 μm during mold casting, wherein a majority by volume of the SiO₂ particles have particle sizes in a range of between 1 μm and 50 μm, and wherein the green body is densified by heating in a hydrogen-containing atmosphere.

9. The method according to claim 8, wherein the amorphous SiO₂ particles have particle sizes in a range of not more than 50 μm during slip casting.

10. The method according to claim 8, wherein a hydrogen content in the hydrogen-containing atmosphere during sintering is at least 70 vol. %.

11. A quartz glass component comprising: a base body of quartz glass having a surface covered at least in part with an SiO₂ glass mass which differs in its optical, physical or chemical properties from quartz glass of the base body, wherein the glass mass is prepared from a dried vitrified slip mass containing amorphous SiO₂ particles, wherein the SiO₂ glass mass is opaque or at least partly opaque and comprises a material with characteristics of a species with respect to the base body.

12. The quartz glass component according to claim 11, wherein the SiO₂ glass mass is formed with a surface free from cracks and without any tools at an average surface roughness Rₐ of at least 0.5 μm.

13. The quartz glass component according to claim 12, wherein the surface of the SiO₂ glass mass has an average surface roughness Rₐ of at least 1.0 μm.

14. The quartz glass component according to claim 11, wherein the SiO₂ glass mass has a thickened portion of the base body.

15. The quartz glass component according to claim 11, wherein the SiO₂ glass mass contains dopants chosen from the group consisting of yttrium, aluminum, nitrogen, carbon and any compounds thereof.

16. The method according to claim 1, wherein a dried slip layer is vitrified by heating said dried slip layer to a temperature ranging from 1100° C. to 1400° C.
